(19) United States
(12) Patent Application Publication
(10) Pub. No.: US 2025/0271832 A1
(43) Pub. Date: Aug. 28, 2025

(54) MACHINE TOOL AND METHOD FOR MACHINING ARTICLES

(71) Applicant: Luca TONCELLI, Bassano del Grappa (VI) (IT)

(72) Inventor: Luca TONCELLI, Bassano del Grappa (VI) (IT)

(21) Appl. No.: 18/577,640

(22) PCT Filed: Jun. 7, 2022
(86) PCT No.: PCT/IB2022/056228

§ 371 Date: Jan. 8, 2024

(30) Foreign Application Priority Data
Jul. 9, 2021 (IT) 102021000018137

(51) Int. Cl. G05B 19/404; G05B 19/401; G05B 19/416; G05B 23/02

(52) U.S. Cl. CPC G05B 19/404; G05B 19/401; G05B 19/416; G05B 23/02; G05B 2219/33002; G05B 2219/50041

(57) ABSTRACT

Method for machining articles by means of a numerical-control machine tool (1) with at least one tool (2) mounted on a rotating spindle (4) and movement means (6), comprising a step i) of carrying out test machining operations on test articles using predetermined operating conditions, a step ii) of detecting at least first values relating to operating parameters of the tool (2) and/or spindle (4) and/or movement means (6) and at least second values relating to the amplitude and the frequency of the vibrations and/or the loads acting on the machine (1), a step iii) of analysing and processing the operating conditions of the first and second values to obtain optimized reference values of the operating parameters, and a step iv) of carrying out one or more machining operations on an article based on the optimized reference values. The step iii) of analysing and processing the operating conditions and the first and second values is performed by means of a process for training a software based on at least one artificial intelligence algorithm. The present invention also relates to a machine tool (1) for machining the articles.

The present invention relates to a machine tool for machining articles.

The invention also relates to a method for machining articles by means of a machine tool.

In the present state of the art numerical-control machine tools intended to carry out the machining of articles, in particular by means of stock removal, are known; said articles may be made of various types of materials, such as stone material, stone-like material, composite material, metals, light alloys or plastic materials.

The machining operations which can be performed by means of these machine tools are many and comprise, for example, milling, contouring, drilling, chamfering, finishing, roughing and other similar machining operations.

Each of the aforementioned machining operations requires a specific machining tool which is mounted on a rotating spindle; the various tools may be removed from a tool-holder magazine provided in the machine tool.

These machines comprise alternatively a machining head provided with the spindle and mounted, like the spindle, on the bottom end of a sleeve.

The sleeve is displaceable so as to move the spindle or the machining head with the respective spindle and machining tool towards or away from the support surface for the articles.

Furthermore, the sleeve with the spindle or with the respective machining head are movable relative to the support surface for predefined positioning of the machining tool with respect to each point of the support surface.

This latter movement of the sleeve and the spindle/machining head is performed by means of suitable movement means, preferably of the Cartesian type or alternatively of the anthropomorphic type.

Below reference will be made to a possible configuration of a machine tool, without this being regarded as limiting the scope of protection of the present invention.

In a manner known per se, in this configuration the Cartesian movement means comprise a pair of lateral support structures, a slidable horizontal beam supported at its ends on top of the lateral structures and a carriage slidable along the beam, the sleeve with the machining head being mounted on the carriage slidable in the vertical direction; the anthropomorphic movement means comprise preferably a robotic arm.

One drawback of these solutions consists in the fact that these machine tools are frequently subject to vibrations with variable amplitudes and frequencies during the machining operations, in particular in the case of machining which requires forces of significant intensity or the use of particular operating conditions.

“Operating conditions” is understood as meaning, for example, the type of tool used for machining, the type of material of the articles to be machined, the type of machining operation with the associated machining parameters (for example finishing or roughing) to be carried out on articles, or the shapes and sizes of the articles.

The vibrations spread from the machining tool to the other components of the machine tool, even resulting in resonance which affects the machine tool.

This phenomenon is also known in other sectors, such as the motorcycling sector, where it is referred to by the term “chattering”.

Furthermore, during the machining operations, the machine tools or some of their components are subject to particularly intense loads and/or forces.

The term “load” is understood as meaning the set of actions exerted on a structure which generate a state of tension and/or the system of applied forces which may result in a state of stress and consequently deformation in the structure.

The components which are most susceptible to vibrations and/or loads are the sleeve, the sliding beam and the guiding and support means, such as the bearings or sliding guides. However, the other components of the machine tool may likewise be affected by the vibrations and/or resonance and/or loads.

The aforementioned drawbacks may have negative consequences both on the quality of machining of the article and on the intact condition of the machine tool, namely:
the machined zones of the articles may have imperfections, irregularities or corrugations;
the various components of the machine tool are subject to significant forces, with consequent possible damage and consequent possible need for replacement/maintenance/repair.

In order to overcome at least partly these drawbacks machine tools which use passive or active vibration damping and attenuation systems or machine tools which have special configurations such as to reduce the vibrations and/or loads acting on the machine tool have been developed.

The passive damping systems may comprise, for example, resonant mass damping devices or other similar devices mounted on the sleeve or on the machining head or on the spindle; the active damping systems may comprise sensors for detecting the vibrations, such as accelerometers, connected to the damping devices described above.

These sensors are positioned in the zones of the machine tool which are most subject to vibrations and resonance and are intended to activate the damping devices or to adjust certain machining parameters relating to the machining tool, the spindle or the movement means. Alternatively, the machining tools with a special form may for example have an end-piece, of suitable length, to be mounted on the rotating spindle in order to reduce the vibrations during machining of the articles.

These technical solutions, although widely used, are not without a number of drawbacks.

Firstly, the aforementioned damping systems react with a delay when vibrations occur, in order to dampen them. The delayed reaction of the damping system, however, does not prevent the formation of defects on the machined surfaces of the articles.

Therefore, in these machine tools, the reduction of the vibration is limited and does not avoid entirely either damage to the components nor the formation of imperfections, irregularities or corrugations on the surface of the material during machining of the articles.

A further drawback consists in the fact that these solutions are not very flexible and are particularly costly.

The main object of the present invention is to provide a machine tool and a method for machining articles, which are able to solve the aforementioned problems.

A particular task of the present invention is to provide a machine tool for machining articles which is able to eliminate the risk of intense and dangerous vibrations arising and affecting the machine components during the machining operations, in particular in the case of machining which requires a large amount of force.

A further task of the present invention is to provide a machine tool of the type indicated above which prevents the formation of vibrations which have a significant amplitude and frequency or in any case which are dangerous during machining.

Another task of the present invention is to provide a machine for machining articles which is not subject to resonance as a result of the vibrations and which prevents machining in conditions close to resonance conditions in the event of vibrations being generated.

Another task of the present invention is to provide a machine tool of the type described above which allows the execution of precise machining operations substantially without imperfections, defects or corrugations which are normally caused by the vibrations.

Another task of the present invention is to provide a machine tool of the type described above which has a limited complexity.

Another task of the present invention is to provide a machine tool of the type described above which does not require the use of machining tools which are modified with respect to the machines known in the sector in order to prevent the vibrations affecting the components.

Another task of the present invention is to provide a method for machining articles by means of a machine tool which allows machining operations to be carried out on articles which are substantially free from imperfections or defects and more rapidly compared to the methods known in the sector.

A further task of the present invention is to provide a method of the type described above in which the quality of the machining operations carried out on the articles is not affected by the vibrations acting on the machine tool.

The object and the main tasks described above are achieved with a method for machining articles according to claim 1 and with a machine tool for machining articles according to claim 16.

In order to illustrate more clearly the innovative principles of the present invention and its advantages compared to the prior art, an example of embodiment of a machine tool for machining articles will be described below with the aid of the attached figures. In particular:

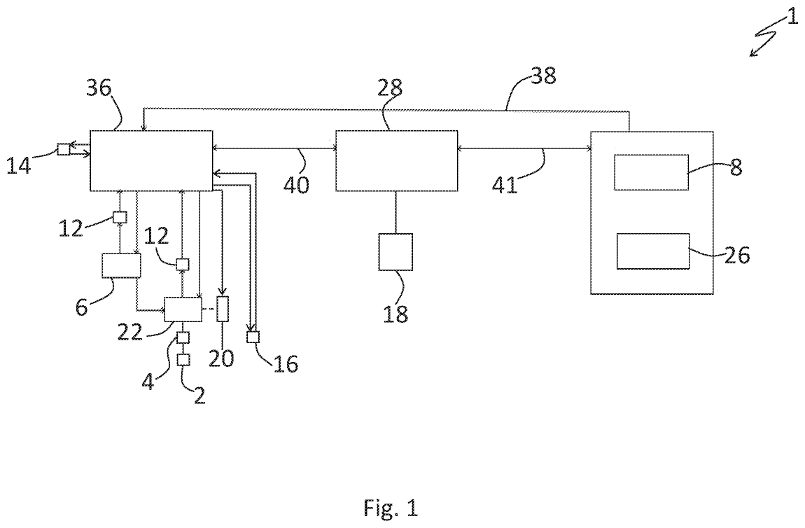

FIG. 1 shows a schematic block diagram of the control system of the machine tool for machining articles according to the present invention;

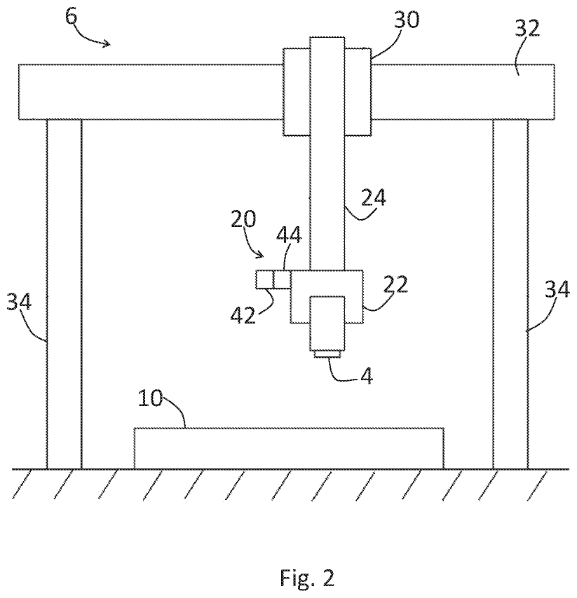

FIG. 2 shows a front schematic view of the configuration of the machine tool for machining articles according to the present invention;

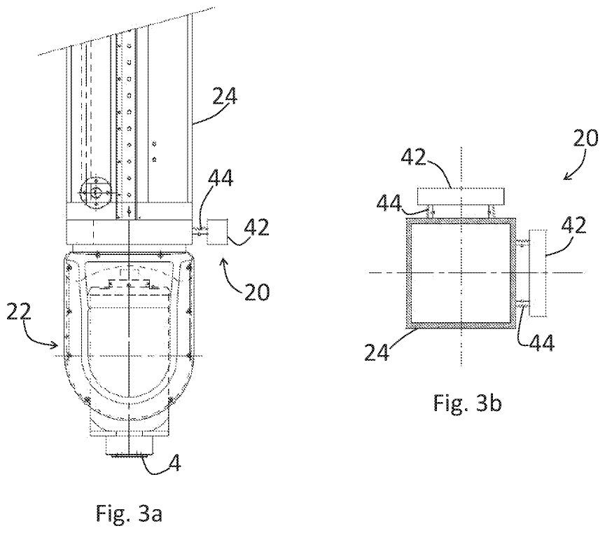

FIGS. 3a-3b show a front cross-sectional view of a detail of the machine tool according to a first embodiment;

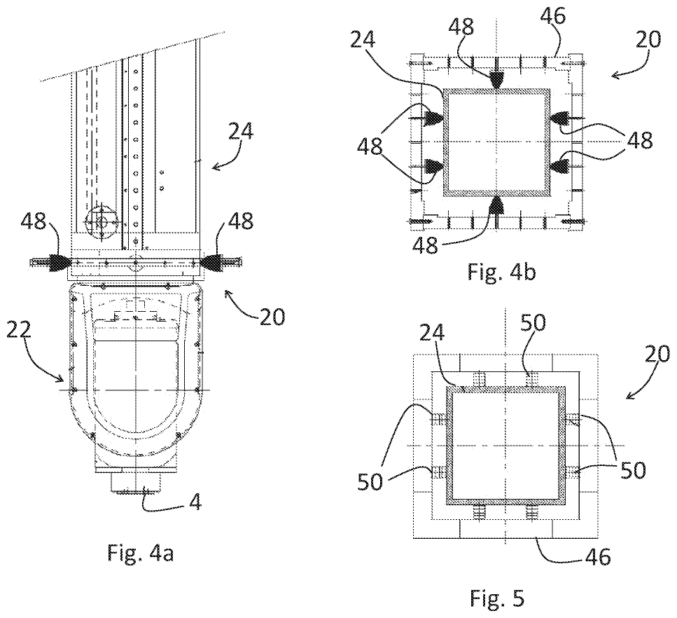

FIGS. 4a-4b show a front cross-sectional view of a detail of the machine tool according to a second embodiment;

FIG. 5 shows a cross-sectional view of a detail of the machine tool according to a third embodiment;

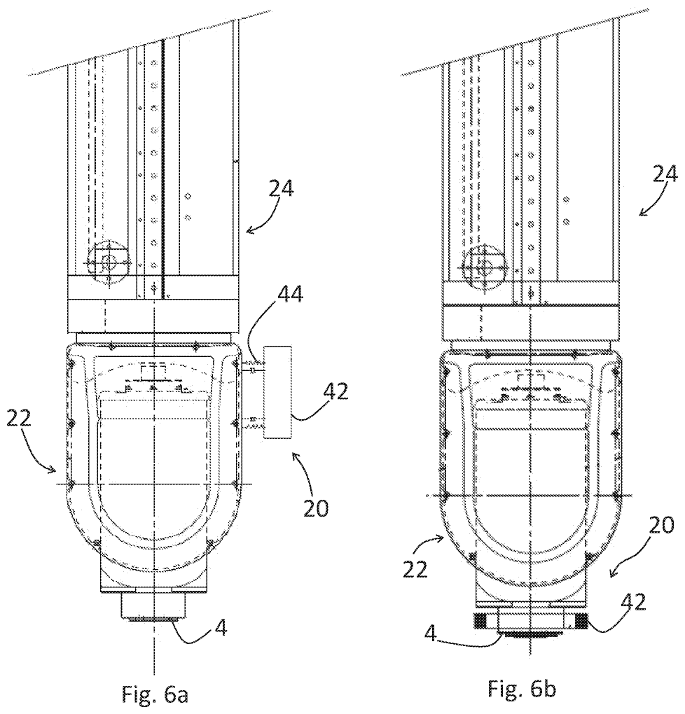

FIGS. 6a-6b show front views of a detail of the machine tool according to a fourth and fifth embodiment, respectively;

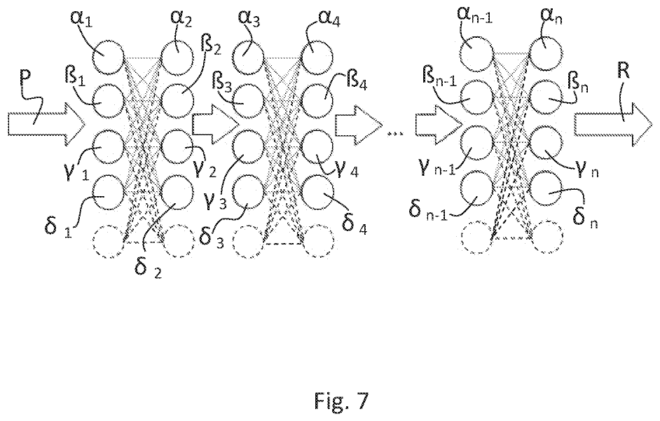

FIG. 7 shows in schematic form a deep neural network model used in the present invention.

The present description, provided only for illustrative purposes and not limiting the scope of the invention, refers to a method and to machine tool for machining articles.

With particular reference to FIGS. 1 and 2 the machine tool for machining articles is indicated overall by the reference number 1.

However, FIG. 2 does not show the computerized numerical control system (CNC) and the processing unit of the machine tool, which are described in detail below.

By way of example, the types of machining operations which can be performed by the machine tool 1 according to the present invention are generally stock-removal machining operations and may comprise milling, contouring, drilling, chamfering, finishing, roughing and other similar machining operations.

The execution of each of the machining operations indicated above presupposes the use of a specific machining tool; the machining tool is designed to be removably mounted on a rotating spindle, which may be installed on a machining head of the machine tool 1.

The various types of machining tool which can be used in the machine tool and in the method of the present invention may be distinguished from each other, for example, by the type of material from which they are made, their diameter or the form or the number of cutting edges.

The machining tool, when it is not used, may be stored in a magazine, not shown in the attached figures, provided in the machine tool.

Moreover, the articles which undergo machining may be made using various types of material and may have different forms and sizes. The articles are not shown in the attached figures. By way of example, the materials of the articles may have different hardness factors and may comprise stone or stone-like materials or composite materials or metals or their alloys, or plastic materials.

The machine tool 1 for implementing the machining method according to the present invention is preferably a numerical-control machine with a dedicated software and comprises mainly at least one machining tool 2 mounted on a respective rotating spindle 4.

Moreover, this machine tool 1 comprises movement means 6 for moving the at least one machining tool 2 and the spindle 4.

However, in the attached figures, the machining tool 2 is shown only schematically in FIG. 1; in FIG. 2, the spindle 4 shown is mounted on a machining head 22 and is without the machining tool 2.

The machining method comprises preferably the following steps:
i) carrying out one or more test machining operations on one or more test articles by means of the at least one machining tool 2 using predetermined operating conditions;
ii) detecting and collecting at least first values relating to operating parameters of the at least one machining tool 2 and/or spindle 4 and/or movement means 6 and at least second values relating to the amplitude and frequency of the vibrations affecting the machine tool 1 and induced by machining, and/or the loads and the forces acting on the machine tool 1.
iii) analysing and processing the operating conditions and the first and second values detected during said step ii) in order to derive and obtain optimized reference values of the operating parameters of the at least one machining tool 2 and/or spindle 4 and/or movement means 6;
iv) carrying out one or more machining operations on an article by means of the at least one machining tool 2, based on the optimized reference values of the operating parameters.

In the context of the present description, the optimized reference values of the operating parameters are such that, in the machine tool 1, the vibrations and/or resonance phenomena are absent or reduced and the machining operations carried out on the articles are devoid or substantially devoid of irregularities and/or imperfections and/or defects and/or corrugations.

Advantageously, the predetermined operating conditions used during step i) may comprise the type of the at least one machining tool 2 and/or the type of the material of the articles and/or the type of machining to be carried out on the articles and/or the shapes and sizes of the articles, as indicated above and/or the operating conditions associated with the environment in which the production process takes place.

For each step i) involving the production of test samples, instructions are also defined for adjusting the operating parameters of the at least one machining tool 2 and/or spindle 4 and/or movement means 6.

These operating instructions and conditions are associated with respective production processes, discussed further below with reference to the processing step iii), and with respective abstraction models obtained from the data detected during these production processes.

The predetermined operating conditions used to carry out one or more test machining operations on the articles during step i) may correspond to the operating conditions used to carry out one or more machining operations on the articles during step iv).

The information relating to the predetermined operating conditions and the instructions indicated above may be entered directly by the operator into the numerical control system 8 of the machine tool 1; alternatively, the operating conditions may also be detected, in the same way as the first and second values, during step ii) or at a different time.

In an alternative embodiment of the present invention, step i) may be performed by means of a mechatronics model of the numerical-control machine tool 1, not shown in the figures; Suitably, the operating parameters, the first values of which are detected during step ii) may comprise:
the torque applied to the rotating spindle 4; and/or
the number of rotations of the rotating spindle 4; and/or
the peripheral speed of the at least one machining tool 2; and/or
the speed of advancing movement of the movement means 6; and/or
the position and/or orientation of the at least one machining tool 2; and/or
the machining depth of the at least one machining tool 2 with respect to the external surface of the article; and/or
the machining zone covered by the tool 2.

The above list is provided only by way of a non-limiting example of the scope of protection of the present invention.

During step ii) third values, in addition to the first and second values indicated above, may be detected and collected; these third value relates mainly to defects and/or imperfections and/or corrugations which may be present on the surfaces of the test articles which undergo machining during step i), i.e. the quality of the machining operation.

In this respect it is emphasized that the first, second and third values are detected, respectively, by means of first automatic detection means 12, second automatic detection means 14 and third automatic detection means 16 which are different from each other.

These automatic detection means are described further below with reference to the machine tool 1 and are shown schematically in FIG. 1.

The third values, in the same way as the first and second values, are intended to be processed during step iii) in order to obtain optimized reference values.

Step ii) of detecting and collecting the first, second and third values may also be carried out at the same time as step i) for carrying out one or more test machining operations.

Alternatively or in combination, step ii) may be carried out during step iv) for carrying out one or more machining operations on the article.

In the embodiment of the method which involves the detection of the values during step iv), the values detected during this step and then processed in order to obtain the optimized reference values are used to prevent the formation of defects and imperfections during the subsequent machining of further articles, preventing the generation of dangerous or damaging vibrations and/or resonance in the machine tools.

In this case, the article machined during step iv) indicated above may constitute a test article for carrying out one or more test machining operations and for detecting the first, second and third values.

If step i) is performed by means of a mechatronics model as mentioned above, step ii) for detecting and collecting the values is carried out on the mechatronics model which performs step i).

Advantageously, the analysis and processing step iii) is performed by means of a process for training a software based on at least one artificial intelligence algorithm.

In particular, the at least one algorithm of the artificial intelligence software may be of the machining learning, deep learning and reinforcement learning type or also a combination of the three preceding types.

Furthermore, the first values, the second values and the third values detected during step ii), as well as the predetermined operating conditions, constitute an input for the training process of the at least artificial intelligence algorithm, while the optimized reference values constitute an output of the training process of the at least one artificial intelligence algorithm.

The first values, the second values and the third values detected during step ii) may be uniquely associated with the operating conditions used during step i).

This enables specific optimized reference values to be obtained for each of the operating conditions or for different combinations of operating conditions.

The analysis and processing step iii) performed by means of training of the artificial intelligence software may also be defined as a calibration or learning step.

Consequently, the method according to the present invention may also be defined as being a predictive method for the machining of articles by means of at least one machining tool 2.

The values detected and collected during step ii) for each test article or machined article and processed during step iii) in order to obtain the optimized reference values may be defined as being a predictive virtual model for the following step iv) for machining a further article.

The predictive virtual model constitutes a “digital twin” of the abstraction model obtained from the data detected during the various production processes for machining the articles. Said predictive virtual model uses advantageously artificial neural network models, such as Recurrent Neural Networks (RNNs) or Long Short-Term Memory (LSTM), regression models or Support Vector Machines (SVM).

In this way, the predictive virtual model allows also the use of historical series of the first values relating to the operating parameters, the second values relating to the frequency and amplitude of the vibrations and the third values for machining quality, so as to provide predefined outputs of the optimized reference values for events which occur or will occur at predetermined time intervals during the machining of the articles.

FIG. 7 shows a multi-level deep neural network model which may be used in the present invention.

The left-hand arrow, forming part of the first level, represents and groups together the inputs P for the processing operation, while the nodes α_{(1, 2, 3, 4, n-1, n)}, β_{(1, 2, 3, 4, n-1, n)}, γ_{(1, 2, 3, 4, n-1, n)} and δ_{(1, 2, 3, 4, n-1, n)} represent, respectively, the first values, the second values, the third values and the operating conditions, of the type indicated above, at the various processing levels.

At the end of the processing operation (last level on the right in the model), optimized reference values which represent the outputs R of the training process are obtained.

The steps i), ii) and iii) may be repeated a predefined number of times in order to store the values and train the at least one artificial intelligence algorithm to process and improve the optimized reference values of the operating parameters of the machine tool 1.

In particular, steps i)-iii) may be repeated for as long as the events generating vibrations and/or resonance affecting the machine tool are absent or in any case of a limited nature and the machining operations carried out on the articles are devoid or substantially devoid of irregularities and imperfections, such as corrugations.

For this purpose, the first values, the second values and the third values detected during step ii) may be stored in at least one database 18 so as to define a storage step, each test article being related to a corresponding series of first values, second values and/or third values and/or predetermined operating conditions.

The first, second and third values allow continuous training of the artificial intelligence software to be performed, namely also after step i), step ii) and step iii) of the method have been completed and also during the subsequent machining of further articles during step iv). Moreover, during step iv) the optimized reference values extrapolated from operating conditions different from those used during step i) may also be used.

The software based on at least one artificial intelligence algorithm is configured to adjust and implement the dedicated software of the numerical control system 8 based on the optimized reference values obtained with the analysis and processing step iii).

In particular, the software based on at least one artificial intelligence algorithm is preferably configured to adjust the first values regarding the operating parameters contained in a work program or procedure based on the optimized reference values.

The work program is intended to be loaded into the numerical control system 8 of the machine tool 1 and is originally obtained by means of a CAM software based on a solid model of the article to be machined obtained by means of CAD software. Said CAM and CAD software may also be interfaced with the artificial intelligence software.

The work program contains essentially the instructions regarding the operations and the displacement trajectories of the at least one machining tool 2, but may also contain the predetermined operating conditions to be used for specific machining operations.

The method may also comprise a step of defining threshold values for the second values relating to the amplitude and frequency of the vibrations affecting the machine tool 1 and induced by the vibrations, and/or the loads and the forces to which the machine tool 1 is subject.

These threshold values may also be obtained following the analysis and processing step iii) performed by the artificial intelligence software, as well as the optimized reference values. Should the artificial intelligence software be unable to limit the amplitude and the frequency of the vibrations to within threshold values, the numerical control system 8 of the machine tool 1, suitably implemented based on the optimized reference values and the threshold values as described above, is alternatively configured to:
alert the operator and/or
activate any system 20 provided for damping the vibrations and/or
stop operation of the machine tool 1.

Therefore, the abovementioned actions managed by the numerical control system 8 are implemented when the second values relating to the amplitude and the frequency of the vibrations and/or the loads exceed the threshold values.

As already mentioned, the present invention also relates to a machine tool 1 for machining articles. FIG. 1 shows in schematic form a particular configuration of the control system of the machine tool 1 and FIG. 2 shows a simplified front view of the machine tool 1.

Preferably, the machine tool 1 of the configuration chosen as an example of embodiment comprises:
a support surface 10 for the articles to be machined;
at least one rotating spindle 4 comprising a machining tool 2;
movement means 6 for moving the at least one rotating spindle 4 with respect to the support surface 10;
first means 12 for automatic detection of the first values relating to the operating parameters of the at least one machining tool 2 and/or spindle 4 and/or movement means 6;
second means 14 for automatic detection of the second values relating to the frequency and the amplitude of the vibrations induced by machining and affecting the machine tool 1, and the loads and forces acting on the components of the machine tool 1;
a computerized numerical control system 8 (CNC) associated with a PLC 26 and having a dedicated software for controlling the at least one rotating spindle 4, the machining tool 2, the movement means 6, the first automatic detection means 12 and the second automatic detection means 14;
a processing unit 28, in particular a high-performance processing and calculating unit with an installed software.

The at least one machining tool 2 may be of a different type depending on the material of the articles to be machined and the type of machining operation to be performed, as indicated above with reference to the method.

The at least one rotating spindle 4 is preferably mounted on a machining head 22, in turn mounted on the bottom end of a sleeve 24 slidable towards and away from the support surface 10, as schematically shown in FIG. 1.

The CNC 8 and the PLC form a command unit for managing the machine tool 1.

The movement means 6 may also be of the anthropomorphic type, namely comprise a robotic arm.

Alternatively, as shown in FIG. 2 in relation to the particular type of machine, the movement means 6 are of the Cartesian type, namely they comprise a carriage 30 slidably mounted on a horizontal beam 32 also slidably mounted at its ends on a pair of side shoulders 34.

The carriage 30 supports the vertically sliding sleeve 24 on which the at least one machining head 22 is mounted.

The machine tool 1 may also comprise a local control unit 36 connected to the at least one machining tool 2, to the at least one spindle 4, to the movement means 6 and to the automatic detection means 12, 14, as shown schematically in FIG. 1.

The local control unit 36 advantageously performs an edge computing time processing.

Furthermore, the local control unit 36 is connected to the CNC 8 by means of a dedicated connection 38 and to the high-performance processing unit 28 by means of a further dedicated connection 40. In turn, the processing unit 28 is connected to the CNC 8 by means of a further dedicated connection 41.

The dedicated connections 38, 40, 41 are preferably of the Ethernet type and are shown in schematic form in FIG. 1.

The processing unit 28, or at least a part thereof, may be integrated in the machine tool 1 or may be external to the machine tool 1.

The software of the processing unit 28 is based on at least one self-learning/automatic learning artificial intelligence algorithm.

In fact, the artificial intelligence software of the processing unit 28 allows execution of the step iii) for analysis and processing of the values described above with reference to the method.

Advantageously, the artificial intelligence software may operate on the basis of the processes and the models described above with reference to the method.

The processing unit 28 may also be formed by a controller integrated in the machine tool 1 and by a high-performance calculation unit located external to the machine tool and connected to the controller. This configuration is not shown in the attached figures.

Advantageously, a first module of the software based on the at least one artificial intelligence algorithm is installed in the controller and a second module of the software based on the at least one artificial intelligence algorithm is installed in the high-performance calculation unit. The first automatic detection means 12, shown schematically in FIG. 1, may be associated at least indirectly with the at least one machining tool 2 and/or the spindle 4 and the movement means 6 in order to detect and collect the first values relating to the operating parameters, as schematically shown in FIG. 1.

These operating parameters are the same ones indicated above with reference to step ii) of the method.

For this purpose, the first automatic detection means 12 are chosen in a non-limiting manner from the group comprising encoders, gyroscopes, lasers, sensors for detecting the torque applied to the spindle 4 and sensors for detecting the number of revolutions of the spindle 4. By way of example, the second automatic detection means 14 may be vibration sensors, such as accelerometers, and sensors or force transducers, such as load cells or piezoelectric devices. Furthermore, the machine tool 1 may also comprise third means 16, shown schematically in FIG. 1, for automatically detecting the third values indicated above and relating mainly to the formation of defects and/or irregularities and/or imperfections and corrugations on the surface of the articles during machining thereof.

For this purpose, the third detection means 16 may comprise at least one telecamera and at least one thermal camera or at least one laser blade profilometer or at least one scanner.

Furthermore, the third automatic detection means 16 are connected to the CNC 8, preferably via the local control unit 36.

If necessary, the third automatic detection means 16 may also comprise acoustic sensors for detecting the noise generated during the article machining process.

In an alternative embodiment of the invention, the third values may also be detected by the operator of the machine tool 1 using suitable equipment and loaded into the control unit of the machine 1.

The high-performance processing unit 28 with the software based on the at least one artificial intelligence algorithm is configured to receive the values from the first automatic detection means 12, second automatic detection means 14 and third automatic detection means 16, preferably via the local control unit 36, in order to process said values and obtain the optimized reference values of the operating parameters and the threshold values from said values.

As already mentioned, the first values, the second values and the third values, as well as the predetermined operating conditions, constitute an input for the processing performed by the processing unit 28, while the optimized reference values constitute an output of the processing performed by the processing unit 28.

One or more databases 18 may also be associated with the processing unit 28, in particular with the high-performance calculation unit, and be configured to store respectively the values detected by the first automatic detection means 12, second automatic detection means 14, and third automatic detection means 16, the predetermined operating conditions and the threshold values.

The artificial intelligence software formed by the two modules as described above and installed in the processing unit 28 is configured to implement the dedicated software of the computerized numerical control system 8 of the machine tool 1 based on the optimized reference values.

In particular, the second module of the software installed in the high-performance calculation unit of the processing unit 28 is able to process a considerable amount of values detected during step ii) and send them to the controller for adjustment and implementation of the computerized numerical control 8 of the machine tool 1.

Furthermore, the software of the processing unit 28, by means of repetition of step iii) for analysis and processing of the new values which it continues to receive from the detection means 12, 14, 16 on the test articles, continues to be trained so that the optimized reference values which can be obtained at the end of processing are increasingly improved.

As already mentioned above, the artificial intelligence software may adjust and implement the dedicated software of the machine tool 1 by adjusting the operating parameters and/or the predetermined operating conditions contained in a work program based on the optimized reference values.

The work program is designed to be loaded into the computerized numerical control system 8 and is originally realized by means of CAM software based on a three-dimensional model of the article.

Consequently, the machining of the articles is performed on the basis of the values collected beforehand and processed by means of training of a software based on the at least one artificial intelligence algorithm.

The machine tool 1 may comprise advantageously at least one vibration damping system 20 associated with at least the machining head 22 or the sleeve 24 or the spindle 4.

Moreover, the at least one damping system 20 is connected to the computerized numerical control system 8 of the machine tool 1 for selective operation by the same, preferably via the local control unit 36 as schematically shown in FIG. 1.

In particular, the at least one damping system 20 is intended to be activated when the software based on at least one artificial intelligence algorithm determines that the defined or processed threshold values relating to the frequency or the amplitude of the vibrations and/or loads during step iv) will be exceeded.

Alternatively, the at least one damping system 20 may be activated when the artificial intelligence software determines that the frequency of the vibrations may assume values which are damaging for the machine or that the machine may enter into the resonance condition or approach said condition.

The actions of the at least one damping system 20 activated by the CNC 8 following the divergence of the values detected during step iv) from the threshold values have been indicated above with reference to the method.

FIGS. 3a-3b, 4a-4b, 5, and 6a-6b show five embodiments of the at least one damping system 20 which can be selectively activated, in particular:
FIGS. 3a and 3b show a first embodiment in which the system 20 comprises a damping mass 42 which can be selectively activated and a respective elastic connection 44; the damping mass 42 is positioned on the sleeve 24 so that its action is exerted along a direction transverse to the direction of vertical sliding of the sleeve 24 and the elastic connection 44 allows the mass 42 to vibrate in phase-opposition to the vibration of the machine tool 1;
FIGS. 4a and 4b show a second embodiment in which the damping mass is formed by a ring 46, which is preferably rectangular, and the elastic connection between the ring 46 and the sleeve 24 is obtained by means of a plurality of elastomeric damping elements 48, or “cushions”, which can be selectively activated; the ring 46 may comprise a plurality of holes, not visible in the figures, for inserting one end of the damping elements 48;
FIG. 5 shows a third embodiment of the damping system 20 which comprises a plurality of air springs 50 as elastic connections replacing the elastomeric damping elements 48 of the second embodiment; these air springs 50 can also be selectively activated and adjusted;
FIG. 6a shows a fourth embodiment of the damping system 20 in which the damping mass 42 which can be selectively activated is provided on the machining head 22;
FIG. 6a shows a fifth embodiment of the damping system 20 in which the damping mass 42 which can be selectively activated is provided on the spindle 4 and has a ring-like form. In the schematic block diagram view of FIG. 1, the at least one damping system 20 is associated by way of example with the machining head 22.

From the above description it is now clear how the method and the machine tool according to the present invention are able to achieve advantageously the predefined objects.

In particular, by means of training of the software based on the at least one artificial intelligence algorithm and the subsequent adjustment and implementation of the dedicated software of the computerized numerical control system based on the optimized reference values, the machining of the articles may be performed preventing in advance the vibrations and the resonance affecting the machine tool or reducing the intensity of the vibrations or avoiding given vibration frequencies which are dangerous or damaging.

Should the artificial intelligence software be unable to prevent the generation of dangerous or damaging vibrations or resonance in the machine, the numerical control system 8 suitably implemented by the artificial intelligence software is configured to alert the operator and/or to activate the at least one system 20 in order to dampen the vibrations and/or stop operation of the machine tool 1.

In this way, the surfaces of the articles machined by means of the machine tool according to the present invention are devoid or substantially devoid of irregularities and/or imperfections and/or defects, such as corrugations.

Moreover, with the method and the machine tool according to the present invention it is possible to carry out the machining operations on the articles more rapidly compared to the methods and the machines known in the sector.

Obviously, the above description of embodiments applying the innovative principles of the present invention is provided by way of example of these innovative principles and must therefore not be regarded as limiting the scope of the rights claimed herein.

1. A method for machining articles by means of a numerical-control machine tool comprising at least one machining tool mounted on at least one rotating spindle and movement means for moving the at least one machining tool and the spindle, comprising the following steps:
(i) carrying out one or more test machining operations on one or more test articles by means of the at least one machining tool using predetermined operating conditions;
(ii) detecting and collecting at least first values relating to operating parameters of the at least one machining tool and/or spindle and/or movement means and second values relating to the amplitude and frequency of the vibrations affecting the machine tool and/or the loads and the forces acting on the machine tool;
(iii) analysing and processing said operating conditions and said first and second values detected during said step (ii) in order to derive and obtain optimized reference values of said operating parameters;
(iv) carrying out one or more machining operations on an article by means of the at least one machining tool, based on said optimized reference values of the operating parameters;
wherein said analysis and processing step (iii) is performed by means of a process for training a software based on at least one artificial intelligence algorithm.

2. The method according to claim 1, characterized in that said optimized reference values of the operating parameters are such that, in the machine tool, the vibrations and/or resonance phenomena are absent or reduced and the machining operations carried out on the articles are devoid or substantially devoid of irregularities and/or imperfections and/or defects and/or corrugations.

3. The method according to claim 1, characterized in that, during said step (ii), third values relating to defects and/or imperfections present on the surfaces of the articles being machined are detected and collected, said third values being able to be processed in said step (iii).

4. The method according to claim 1, characterized in that said first values and/or said second values and/or said third values detected during said step (ii) as well as the predetermined operating conditions constitute an input for the processing operation, the optimized reference values constituting an output of the processing operation.

5. The method according to claim 1, further comprising a step of defining threshold values for the second values relating to the amplitude and frequency of the vibrations affecting the machine tool and induced by the machining, and/or the loads and the forces acting on the machine tool.

6. The method according to claim 5, characterized in that the numerical control system of said machine tool is configured to alert the operator and/or to activate a system for damping the vibrations and/or for stopping the operation of the machine tool should the software based on at least one artificial intelligence algorithm be unable to limit the amplitude or the frequency of the vibrations to within certain threshold values.

7. The method according to claim 1, characterized in that the operating parameters comprise the torque applied to the rotating spindle and/or the number of revolutions of the rotating spindle and/or the peripheral speed of the at least one machining tool and/or the speed of advancing movement of the movement means and/or the position and/or the orientation of the at least one tool and/or the depth of machining and/or the width of the machining performed by the at least one machining tool with respect to the external surface of the article and/or the machining zone covered by the machining tool.

8. The method according to claim 1, characterized in that said predetermined operating conditions comprise the type of the at least one machining tool and/or the type of material of the articles and/or the type of machining to be carried out on the articles and/or the shapes and sizes of the articles.

9. The method according to claim 1, characterized in that said software based on at least one artificial intelligence algorithm is configured to adjust the operating parameters of a work program on the basis of said optimized reference values, said work program being intended to be loaded into the numerical control system of the machine tool and being obtained by means of CAM software from a solid model of the article to be machined.

10. The method according to claim 1, characterized in that said step (ii) of detecting and collecting the values is performed during said step (i) for carrying out the test machining operations and/or during said step (iv) of carrying out one or more machining operations on the article.

11. The method according to claim 1, characterized in that said step (i) of carrying out the test machining operations is performed by means of a machine tool mechatronics model.

12. The method according to claim 11, characterized in that said detection and collection step (ii) is carried out during said step (i) performed by means of said machine tool mechatronics model.

13. The method according to claim 1, characterized in that the predetermined operating conditions used to carry out one or more test machining operations on the test articles in said step (i) correspond to the operating conditions used to carry out one or more machining operations on an article during step (iv).

14. The method according to claim 1, characterized in that said steps (i)-(iii) are repeated a predefined number of times so as to store said values and train said at least one artificial intelligence algorithm to process and improve the optimized reference values of the operating parameters of the machine tool.

15. The method according to claim 1, characterized in that the at least one artificial intelligence algorithm is of the machine learning, deep learning and reinforcement learning type or also a combination of the three different types.

16. A machine tool for machining articles comprising:
a support surface for the articles to be machined;
at least one rotating spindle comprising a machining tool;
movement means for moving the at least one rotating spindle with respect to the support surface;
first means for automatically detecting first values relating to operating parameters of the at least one machining tool and/or spindle and/or movement means;
second means for automatic detection of second values relating to the amplitude and frequency of the vibrations induced by machining and affecting the machine tool and the loads and forces acting on the components of the machine tool;
a computerized numerical control system having dedicated software for controlling the at least one rotating spindle, the machining tool, the movement means and the first automatic detection means [(12)] and second automatic detection means;
a processing unit having an installed software;
said processing unit being configured to receive the first and second values from said first automatic detection means and from said second automatic detection means and to process said first and second values so as to obtain optimized reference values of the operating parameters from said first and second values;
wherein the software of said processing unit is based on at least one artificial intelligence algorithm.

17. The machine tool according to claim 16, characterized in that the first automatic detection means are chosen from the group comprising encoders, gyroscopes, lasers, sensors for detecting the torque applied to the spindle and sensors for detecting the number of revolutions of the spindle.

18. The machine tool according to claim 16, characterized in that the second automatic detection means are chosen from the group comprising vibration sensors, for example accelerometers, and force sensors or transducers, for example load cells or piezoelectric devices.

19. The machine tool according to claim 16, further comprising at least one damping system for damping the vibrations associated with the at least one spindle.

20. The machine tool according to claim 19, characterized in that said at least one damping system is connected to the computerized numerical control system of the machine tool for selective operation by the same.

21. The machine tool according to claim 16, further comprising third means for the detection of third values relating to the formation of imperfections or irregularities during machining on the surface of the articles, said third detection means comprising at least one telecamera or at least one thermal camera or at least one laser blade profilometer or at least one scanner.

22. The machine tool according to claim 18, characterized in that the vibration sensors are accelerometers.

23. The machine tool according to claim 18, characterized in that the force sensors or transducers are load cells or piezoelectric devices, respectively.
